(19) United States
(12) Patent Application Publication
(10) Pub. No.: US 2008/0126576 A1
(43) Pub. Date: May 29, 2008

(54) Semiconductor memory device and method for driving the same

(75) Inventor: Se-Kyoung Heo, Kyoungki-do (KR)

Correspondence Address: MCDERMOTT WILL & EMERY LLP, 600 13TH STREET, N.W., WASHINGTON, DC, 20005-3096, US

(73) Assignee: HYNIX SEMICONDUCTOR INC.

(21) Appl. No.: 11/819,813

(22) Filed: Jun. 29, 2007

(30) Foreign Application Priority Data
Nov. 24, 2006 (KR) 2006-0116830

(51) Int. Cl. G06F 3/00

(52) U.S. Cl. 710/4

(57) ABSTRACT

A semiconductor memory device includes a plurality of address pins for receiving a plurality of address signals from a chipset, and an address strobe pin for receiving an address strobe signal from the chipset.

### CROSS-REFERENCE TO RELATED APPLICATIONS

The present invention claims priority of Korean patent application number 2006-116830, filed on Nov. 24, 2006, which is incorporated by reference in its entirety.

### BACKGROUND OF THE INVENTION

The present invention relates to a semiconductor memory device, and more particularly, to a semiconductor memory device capable of receiving an external address signal from a chipset with high stability and reliability, and a method for driving the same.

In semiconductor memory devices, setup time and hold time are defined for inputs of address signals, command signals, or data, which are supplied from external circuits. The external signals can be stably latched when they are input before a predetermined time from the input of an external clock signal. In addition, the external signals can be correctly detected when their levels are maintained for a predetermined time after the input of the external clock signal. At this point, the time interval during which the external signals must be stabilized before the input of the external clock signal is referred to as a setup time, and the time interval during which the external signals must be maintained after the input of the external clock signal is referred to as a hold time.

Meanwhile, the external signals are transferred from a chipset to a dynamic random access memory (DRAM), which is a typical semiconductor memory device, in synchronization with an external clock signal.

FIG. 1 is a block diagram illustrating a transfer path of an external address signal in a conventional system.

Referring to FIG. 1, a transfer path ADDPATH of an external address signal in a conventional system is directed from a chipset to a DRAM. A transfer path CLKPATH1 of a clock signal is directed from a clock generator to the DRAM, and another transfer path CLKPATH2 of the clock signal is directed from the clock generator to the chipset. The chipset and the DRAM operate in synchronization with the clock signal.

However, it can be seen from FIG. 1 that the transfer path CLKPATH1 of the clock signal and the transfer path ADDPATH of the external address signal are different from each other.

That is, a difference between the transfer paths CLKPATH1 and ADDPATH may degrade the reliability and stability of the DRAM operating at high speed.

In other words, when an internal address signal is latched in synchronization with the clock signal that is delayed by a loading difference from the external address signal, the above-described degradation is caused because the decoded external address signal is latched incorrectly due to an insufficient setup time.

As described above, compared with the case where the decoded external address signal is normally latched in synchronization with the clock signal, the clock signal is delayed because the transfer path CLKPATH1 of the clock signal is longer than the transfer path ADDPATH of the external address signal. On the other hand, the reliability and stability of the DRAM operating at high speed are also degraded when the transfer path ADDPATH of the external address signal is longer than the transfer path CLKPATH1 of the clock signal.

### SUMMARY OF THE INVENTION

Embodiments of the present invention are directed at providing a semiconductor memory device capable of receiving an external address signal from a chipset with high reliability and stability, and a method for driving the same.

Embodiments of the present invention are also directed at providing a semiconductor memory device, which can receive an external address signal in synchronization with an address strobe signal transferred from a chipset, and a method for driving the same.

In accordance with an aspect of the present invention, there is provided a semiconductor memory device including: a plurality of address pins for receiving a plurality of address signals from a chipset; and an address strobe pin for receiving an address strobe signal from the chipset.

In accordance with another aspect of the present invention, there is provided a semiconductor memory device including: a plurality of address input units for receiving a plurality of address signals from a chipset; an address strobe input unit for receiving an address strobe signal from the chipset; and an address latch unit for latching the address signals in response to the address strobe signal outputted from the address strobe input unit.

In accordance with another aspect of the present invention, there is provided a method for driving a semiconductor memory device including: receiving an address signal and an address strobe signal from a chipset; and latching the address signal in response to the address strobe signal.

### BRIEF DESCRIPTION OF THE DRAWINGS

FIG. 1 is a block diagram illustrating a transfer path of an external address signal in a conventional system;

FIG. 2 illustrates a transfer path of a write data and a timing diagram of the write data and a data strobe signal;

FIG. 3 is a block diagram illustrating a transfer path of an address signal in a system in accordance with an embodiment of the present invention;

FIG. 4 is a block diagram of an internal address generator of a DRAM shown in FIG. 3;

FIG. 5 is a circuit diagram of a latch unit shown in FIG. 4; and

FIG. 6 is a diagram of a DRAM chip having pads for receiving an address strobe signal.

### DESCRIPTION OF SPECIFIC EMBODIMENTS

Hereinafter, a semiconductor memory device and a method capable of receiving an external address signal from a chipset with high stability and reliability in accordance with exemplary embodiments of the present invention will be described in detail with reference to the accompanying drawings.

A dynamic random access memory (DRAM), which is a typical semiconductor memory device, has been developed in order to provide high integration and high operation speed. In order to increase the operation speed of the semiconductor memory device, synchronous DRAMs (SDRAMs) have been introduced which operates in synchronization with an external clock signal.

The SDRAMs are generally classified into a single data rate (SDR) SDRAM and a double data rate (DDR) SDRAM. The SDR SDRAM receives/outputs a single data through a single data pin in synchronization with a rising edge of an external clock signal during one cycle of the external clock signal.

The SDR SDRAM, however, is still insufficient to satisfy the required high-speed operation of systems. Accordingly, the DDR SDRAM was proposed which can process two data during one cycle of the external clock signal.

The DDR SDRAM successively receives/outputs two data through data input/output pins in synchronization with a rising edge and a falling edge of the external clock signal. Therefore, the DDR SDRAM can achieve at least twice the bandwidth of the SDR SDRAM. Consequently, the high-speed operation of the semiconductor memory device can be implemented.

However, a data access scheme used in the SDR SDRAM cannot be used because the DDR SDRAM must receive/output two data during one cycle of the clock signal.

For example, when the clock cycle is 10 ns, the DDR SDRAM should successively process two data within about 6 nsec, excluding the rising time and the falling time (about 0.5×4=2 ns), to satisfy other specifications, etc. This process is difficult to perform within the DRAM. For this reason, the DRAM receives/outputs data at the rising edge and the falling edge only when it receives/outputs data from/to the outside, and the two data synchronized with one edge of the clock signal are substantially processed in parallel within the DRAM.

Therefore, the DRAM requires a new data access scheme to transfer data to a core region or output data from the core region to the external circuit.

To this end, a data input buffer of the DDR SDRAM prefetches 2-bit data synchronized with the rising edge and the falling edge. The prefetched data are synchronized as even data or odd data at the rising edge and then are transferred to the core region.

However, as an operation frequency of a central processing unit (CPU) becomes higher, the DRAM must be designed to operate at higher speed. To this end, a data input buffer has been proposed which can prefetch 4-bit data.

Meanwhile, a data strobe signal is also input from a CPU or a memory controller chipset together with a data signal in order to achieve correct data input/output timing.

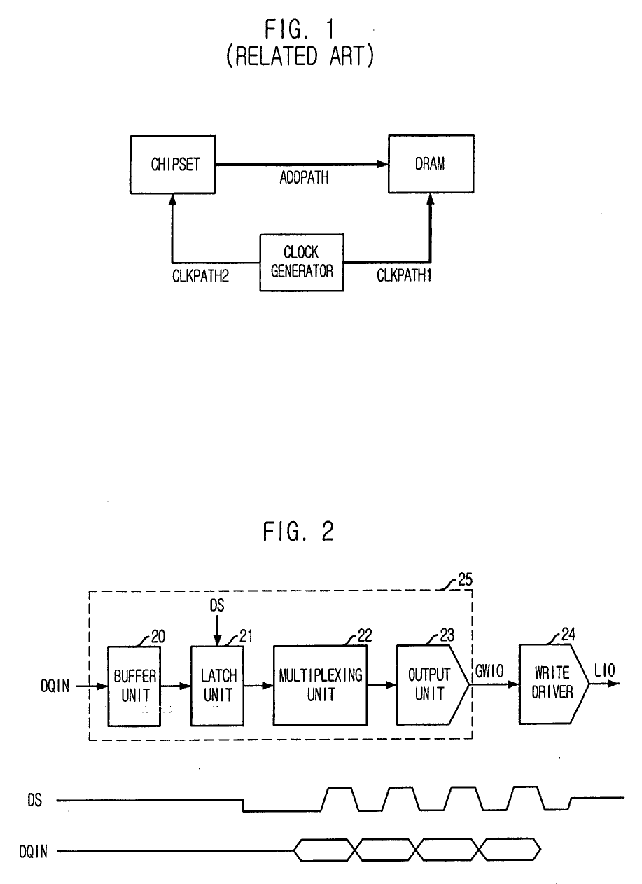

FIG. 2 illustrates a transfer path of a write data and a timing diagram of the write data and a data strobe signal.

As shown, a write data DQIN is transferred to a memory cell-through a DQ part 25, a global input/output line GWIO, a write driver 24, a local input/output line LIO, and a bit line. The DQ part 25 includes a buffer unit 20, a latch unit 21, a multiplexing unit 22, and an output unit 23.

The buffer unit 20 buffers the external write data DQIN on the basis of data level used for the internal operation of the DRAM. The latch unit 21 latches the buffered external write data DQIN based on the data strobe signal DS.

The multiplexing unit 22 matches the latched write data DQIN to a write address signal. The output unit 23 transfers the matched write data DQIN to the global input/output line GWIO.

As described above, the write data DQIN is latched in response to the data strobe signal DS.

The present invention applies the data transfer scheme to an address transfer between the DRAM and the chipset. In receiving the address signal, the DRAM receives the address strobe signal together with the address signal from the chipset provided outside the DRAM in order to achieve the correct input/output timing of the address signal.

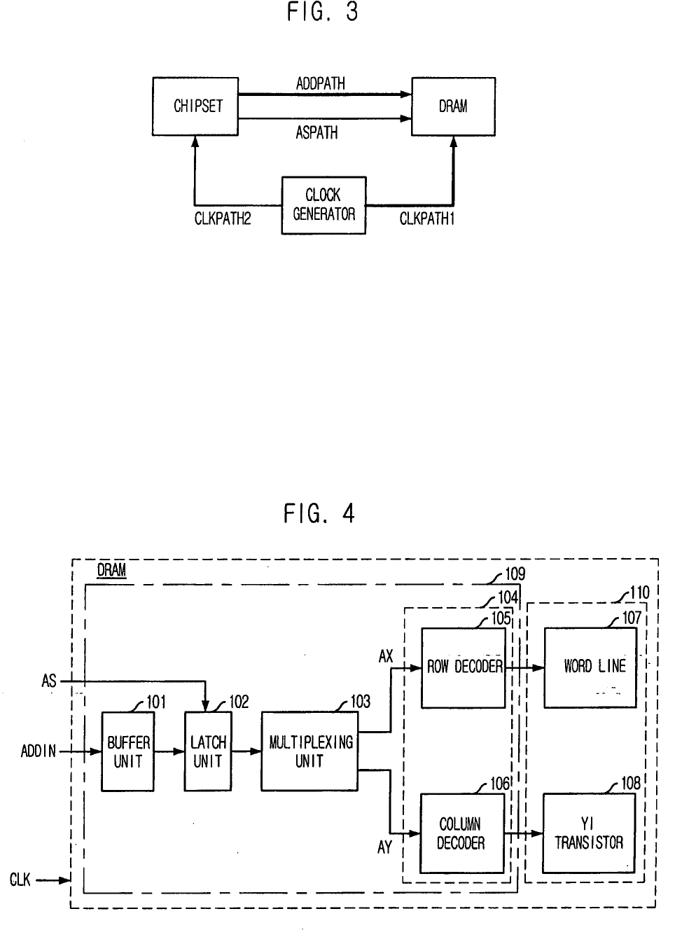

FIG. 3 is a block diagram illustrating a transfer path of an address signal in a system in accordance with an embodiment of the present invention.

As shown, a transfer path ADDPATH of an external signal is directed from a chipset to a DRAM. A transfer path of a clock signal CLKPATH1 is directed from a clock generator to the DRAM, and another transfer path CLKPATH2 of the clock signal is directed from the clock generator to the chipset. The chipset and the DRAM operate in synchronization with the clock signal.

The chipset outputs an address signal and an address strobe signal. The address strobe signal is generated for a correct input/output timing of the address signal when the address signal is transferred between the chipset and the DRAM.

The transfer path ADDPATH of the address signal and a transfer path ASPATH of the address strobe signal have the same loading. The correct input/output timing of the address signal in the system can be implemented using the address signal and the address strobe signal transferred through the same loading.

FIG. 4 is a block diagram of an internal address signal generator of the DRAM shown in FIG. 3.

As shown, an internal address generator 109 of the DRAM includes a buffer unit 101, a latch unit 102, a multiplexing unit 103, and a decoding unit 104. Although not shown, the internal address generator 109 further includes an address strobe input unit for receiving an address strobe signal AS from the chipset. The address strobe signal AS is an echo signal of the address signal ADDIN. The address strobe input unit (not shown) may be implemented with a buffer for buffering the address strobe signal.

Specifically, the buffer unit 101 is an address input unit for receiving a plurality of external address signals ADDIN. The buffer unit 101 buffers the external address signals ADDIN on the basis of address signals used for the internal operation of the DRAM. The latch unit 102 latches the buffered external address signals ADDIN based on the address strobe signal AS. The multiplexing unit 103 outputs a row decoding signal AX and a column decoding signal AY by matching the latched external address signals ADDIN to corresponding ones of address information.

The decoding unit 104 includes a row decoder 105 and a column decoder 106. The row decoder 105 decodes the row decoding signal AX so that a corresponding word line 107 can be selected during an active operation. The column decoder 106 decodes the column decoding signal AY so that a corresponding YI transistor 108 can be selected during read/write operations. The YI transistor 108 is a transistor for connecting a bit line to a segment input/output line and corresponds to a column selection circuit.

As described above, the internal address generator 109 receives the external address signals ADDIN in response to the address strobe signal AS. While the conventional internal address generator receives the external address signals in response to the external clock signal, the internal address generator in accordance with the present invention receives the external address signals in response to the address strobe signal AS transferred through the same loading as the external address signals ADDIN.

In this manner, the DRAM in accordance with the present invention can solve the skew problem that is caused between the clock signal and the external address signal because the transfer path CLKPATH1 of the clock signal between the clock generator and the DRAM is different from the transfer path ADDPATH of the address signal between the chipset and the DRAM.

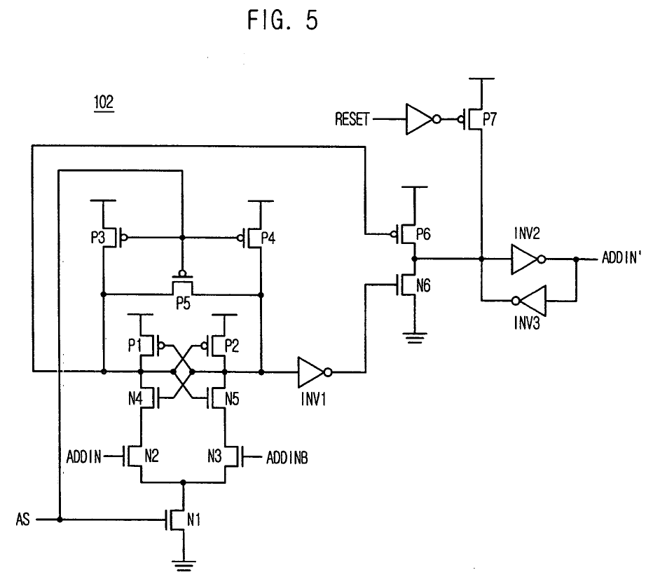

FIG. 5 is a circuit diagram of the latch unit 102 shown in FIG. 4. Since the latch unit 102 is similar to the conventional latch unit that latches the external address signals in response to the clock signal, a detailed description of its circuit configuration will be omitted for conciseness.

Referring to FIG. 5, when the address strobe signal AS is deactivated to a logic low level, three PMOS transistors P3, P4 and P5 are turned on. Therefore, two transistors P6 and N6 do not operate, so that the latch unit 102 does not output the address signals ADDIN. The case where the address strobe signal AS has the logic low level means a state where no external address signals ADDIN are applied to the DRAM.

On the contrary, the case where the address strobe signal AS has a logic high level means a state where the external address signals ADDIN are applied to the DRAM. That is, when the address strobe signal AS changes from the logic low level to the logic high level, an NMOS transistor N1 is turned on so that the latch unit 102 is enabled. The three PMOS transistors P3, P4 and P5 are turned off and the external address signals ADDIN are inputted.

In such a state, the transistors P6 and N6 operate to output the external address signals ADDIN. The latch circuit 102 can be implemented with inverter latch including two inverters INV2 and INV3 for latching the external address signals ADDIN, thereby outputting the latched external address signals ADDIN′.

As a result, the external address signals ADDIN is latched and outputted when the address strobe signal AS changes from the logic low level to the logic high level.

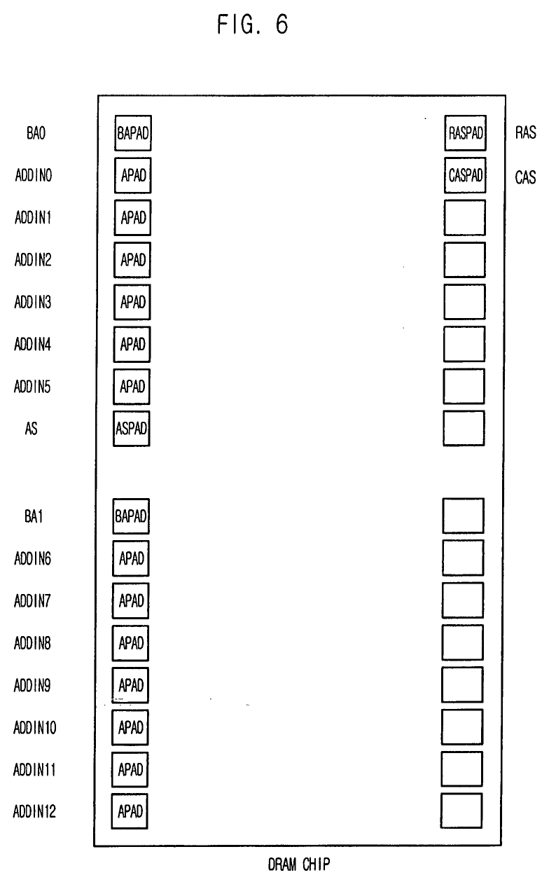

FIG. 6 is a diagram of a DRAM chip having a plurality of pads for receiving an address strobe signal.

As shown, the DRAM chip includes two bank address pads BAPAD for receiving external bank select signals BA0 and BA1, a plurality of address signal pads APAD for receiving external address signals ADDIN0 to ADDIN12, and an address strobe signal pad ASPAD for receiving an address strobe signal AS.

Each of the plurality of address signal pads APAD and the address strobe signal pad ASPAD is wire-bonded to a corresponding pin to receive the external address signals ADDIN0 to ADDIN12 and the address strobe signal AS transferred from an external circuit.

Further, the DRAM chip includes a plurality of command pins such as a row address strobe (RAS) pad RASPAD and a column address strobe (CAS) pad CASPAD for receiving a plurality of command signals including a CAS signal and a RAS signal.

Because the chipset outputting the external address signal also outputs the address strobe signal through the same path in order for synchronizing the external address signal, the DRAM chip can solve the skew problem that is caused between the clock signal and the external address signal due to the difference between the transfer path of the external clock signal and the transfer path of the address signal.

In the aforementioned embodiments, the kinds and arrangements of the logics have been provided for the case where all the input signals and output signals are high active signals. Therefore, when the active polarities of the signals are changed, the logic implementations will be also modified. The number of these implementations is extensive and their modifications can be easily derived by those skilled in the art.

In addition, it will be apparent that the latch unit may be implemented with various logic circuits.

As described above, the DRAM receives the external address signal from the chipset in synchronization with the address strobe signal that is also transferred from the chipset.

Therefore, the external address signals can be received from the chipset with high stability and reliability, thereby improving the stability and reliability of the semiconductor memory device.

While the present invention has been described with respect to the specific embodiments, it will be apparent to those skilled in the art that various changes and modifications may be made without departing from the spirit and scope of the invention as defined in the following claims.

What is claimed is:

1. A semiconductor memory device, comprising:
a plurality of address pins for receiving a plurality of address signals from a chipset; and
an address strobe pin for receiving an address strobe signal from the chipset.

2. The semiconductor memory device as recited in claim 1, wherein the address strobe signal is an echo signal of the address signal.

3. The semiconductor memory device as recited in claim 1, further comprising a plurality of command pins for receiving a plurality of command signals including a column address strobe signal and a row address strobe signal.

4. A semiconductor memory device, comprising:
a plurality of address input units for receiving a plurality of address signals from a chipset;
an address strobe input unit for receiving an address strobe signal from the chipset; and
an address latch unit for latching the address signals in response to the address strobe signal outputted from the address strobe input unit.

5. The semiconductor memory device as recited in claim 4, wherein the address strobe signal is an echo signal of the address signal.

6. The semiconductor memory device as recited in claim 4, wherein the plurality of address input units includes buffers for buffering the address signals.

7. The semiconductor memory device as recited in claim 4, wherein the address strobe input unit comprises a buffer for buffering the address strobe signal.

8. The semiconductor memory device as recited in claim 4, further comprising:
a multiplexing unit for multiplexing the latched address signals into a row address signal and a column address signal; and
an address decoding unit for decoding the row address signal and the column address signal to generate internal address signals.

9. The semiconductor memory device as recited in claim 8, wherein the address decoding unit comprises:
a row decoder for decoding the row address signal so as to select a corresponding word line during an active operation; and
a column decoder for decoding the column address signal so as to select a corresponding column selection transistor during read/write operations.

10. The semiconductor memory device as recited in claim 9, wherein the column selection transistor connects a bit line to a segment input/output line.

11. A method for driving a semiconductor memory device, the method comprising:
receiving an address signal and an address strobe signal from a chipset; and
latching the address signal in response to the address strobe signal.

12. The method as recited in claim 11, wherein the address strobe signal is an echo signal of the address signal.

13. The method as recited in claim 11, further comprising:
multiplexing the latched address signal into a row address signal and a column address signal; and
decoding the multiplexed row address signal and the multiplexed column address-signal to generate internal address signals.

14. The method as recited in claim 13, wherein the step of decoding the multiplexed row address signal and the multiplexed column address signal includes:
selecting a corresponding word line during an active operation by decoding the row address signal; and
selecting a corresponding column selection transistor during read/write operations by decoding the column address signal.
